(19) United States
(12) Patent Application Publication
(10) Pub. No.: US 2022/0007687 A1
(43) Pub. Date: Jan. 13, 2022

(54) SHELF STABLE LIQUID FLAVORED CONCENTRATE

(71) Applicant: Aly Y. Gamay, Mclean, VA (US)

(72) Inventor: Aly Y. Gamay, Mclean, VA (US)

(73) Assignee: DreamPak LLC, Mclean, VA (US)

(21) Appl. No.: 17/326,292

(22) Filed: May 20, 2021

Related U.S. Application Data
(60) Provisional application No. 63/050,710, filed on Jul. 10, 2020.

(51) Int. Cl. A23L 2/56; A23L 2/385; A23L 2/68; A23L 2/44; A23L 2/60; A23L 2/58

(52) U.S. Cl. CPC A23L 2/56; A23L 2/385; A23L 2/68; A23V 2002/00; A23L 2/60; A23L 2/58; A23L 2/44

(57) ABSTRACT

The disclosed subject matter provides preservative-free liquid flavored beverage concentrate compositions, food package kits comprising such compositions, and methods of preparing such compositions and kits.

### CROSS-REFERENCE TO RELATED APPLICATIONS

This application claims the benefit of U.S. Provisional Application No. 63/050,710, filed Jul. 10, 2020. The entire disclosure of this prior application is hereby incorporated by reference.

### FEDERALLY SPONSORED RESEARCH

None.

### SEQUENCE LISTING

None.

### FIELD OF INVENTION

Disclosed are shelf-stable liquid flavored beverage concentrate compositions comprising lactic acid as an acidulant and antimicrobial agent, kits comprising such compositions, and methods of preparing such compositions and kits.

### BACKGROUND

Current trends for consumer beverages recognize the importance of eliminating bulky water to save energy, reduce shipping costs and release storage space both in retail channels and home. The flavored beverage industry is a multibillion-dollar industry looking for convenience, nutrition, portability, and invigorating flavors. However, the distribution and storage of such beverages are cumbersome. There is a need for a point-of-consumption flavored concentrated composition that works as a liquid water enhancer in small bottles to improve portability and storage and deliver nutritional benefits without any addition of preservatives or artificial chemicals.

One drawback of flavored concentrates in the marketplace is the overly sour taste which may turn off consumers. To deliver a strong background taste, current products in the market rely on high inclusion levels of strong acids like citric acid and malic acid, which impart harshness and astringency to the diluted product and require the presence of buffering agents. Another drawback of current flavored concentrates is that they contain artificial preservatives, which do not appeal to health-conscious consumers.

The present invention provides flavored concentrates with a mild acidic background taste identifiable with naturally occurring fresh fruit flavors, without acid bite, unpleasant sourness, or incorporation of artificial preservatives.

The present invention also provides improved methods using all-liquid ingredients to produce beverage concentrates and ultra-concentrated shelf-stable flavored concentrates and kits comprising such concentrates.

### SUMMARY

The present invention provides shelf-stable, flavored, concentrated compositions that are useful for preparing beverages with enhanced organoleptic profiles and do not require artificial preservatives, as well as methods of preparing such compositions.

In some embodiments, the shelf-stable, flavored, concentrated compositions mimic the flavor profile of natural fruits.

In some embodiments, the shelf-stable, flavored, concentrated compositions lack any off-putting astringency associate with acids such as citric acid and malic acid.

In some embodiments, the shelf-stable, flavored, concentrated compositions comprise exclusively of liquid components for ease and speed of blending during manufacturing.

In some embodiments, the shelf-stable, flavored, concentrated compositions provide superior taste, nutritional benefits, portability, and/or shelf-life compared to commercial concentrates.

In some embodiments, the shelf-stable, flavored concentrated composition do not require the presence of buffering agents.

In some embodiments, the shelf-stable, flavored, concentrated compositions eliminate the need to add any preservatives that exist in commercial concentrates.

Other features and advantages of the present invention will be apparent from this summary and the following description, examples, embodiments, and claims to those skilled in the relevant art.

### Definitions

Unless defined otherwise, all technical and scientific terms used herein have the same meaning as commonly understood by one of ordinary skill in the art to which this invention belongs. Still, certain elements are defined below for the sake of clarity and ease of reference.

“Shelf-stable” means a food product that is microbiologically and chemically stable at ambient temperature (e.g., without the food product substantially breaking down by, for instance, microbial contamination, syneresis, or water accumulation) without refrigeration or freezing for twelve months.

“Ambient” refers to a temperature in the range of about 65° F. to about 85° F.

The term “pH” is used to designate the intensity or degree of acidity. The value of pH, the logarithm of the reciprocal of the hydrogen ion concentration in solution, is usually determined by measuring the difference potential between two electrodes immersed in a sample solution.

The term “water activity level” is defined in the book “Food Science”, Third Edition, A.V.I. (1984) as a qualitative measure of unbound free water in a system that is available to support biological and chemical reactions. In general, as the water activity of a given food product decreases, its shelf life increases. A high-water activity (Aw) product becomes more susceptible to mold, fungus, and bacterial proliferation. For instance, the FDA defines a low acid food product with a pH of greater than 4.6 as shelf-stable only if it has a water activity of 0.85 or less. Two foods with the same water content can vary significantly in their water activity depending on how much free water is in the system. When a food is in moisture equilibrium with its environment, the water activity of the food will be quantitatively equal to the relative humidity in the headspace of the container divided by 100.

Percentages (%) of ingredients of the compositions are expressed as weight unit of ingredients in a total of 100 weight units of the concentrate.

While the numerical parameters setting forth the scope of the disclosed subject matter are approximations, the numerical values set forth in the working examples are reported as precisely as possible. However, any numerical value inherently contains certain errors necessarily resulting from the standard deviation found in its respective testing measurements.

### DETAILED DESCRIPTION

Throughout the specification and claims, percentages are by weight and temperatures in degrees Fahrenheit unless otherwise indicated.

Flavored Beverage Concentrate Compositions

One aspect of the present invention relates to a shelf-stable liquid beverage concentrate composition. The composition uniquely employs lactic acid to impart pleasant acidic notes and enhance the fruit perception of the final beverage.

Unlike prior art technology, the inventive composition does not require any buffering agent to balance out the negative impact of using harsh acids. The inventive composition differs from previously developed commercial concentrates in its use of lactic acid which traditionally is not used in fruit flavored concentrates when compared to other acids like citric acid and malic acid that naturally exist in fruit and impart astringent taste when used at elevated levels and may require the use of buffering agents.

Many liquid concentrates in the prior art include buffers. The inclusion of buffers allows for increased acid content in comparison to an otherwise identical concentrate without buffers. The current technology eliminates or reduces the need for buffers through careful selection of mild acids such as lactic acid. Buffers may also be used to regulate the pH of the concentrate or modify flavor profiles; however, the inventive composition delivers good taste even at much lower pH ranges. Still, the inventive composition may incorporate various levels of buffers if desired to impart different flavor profiles.

Some attempts are known in the art to use acidic combinations since a low pH can have an antimicrobial effect. Nevertheless, there is a difficult balance between the high acidity for desired microbial inhibition and an optimum acidity for the desired beverage flavor for many beverages. Hence, buffering agents are included in some prior art formulations. The selection of strong-tasting acids such as citric acid is necessitated by attempting to deliver high flavor impact in a small serving size of about 2.0-5.0 ml of the concentrate when added to about 250 ml water.

The inventive composition includes several precisely and scientifically selected ingredients at various proportions to achieve varying concentrates depending on final product desired characteristics. In some embodiments, the inventive composition includes lactic acid, flavoring, water, and optional ingredients.

Consumer perception that synthetic food additives may be associated with potential toxicological problems has recently generated interest for the use of naturally derived compounds in the food industry. The use of lactic acid is considered a good alternative and may be more acceptable to consumers than synthetic food additives because of its natural origin, potential antimicrobial activity, as well as functioning as a natural preservative, antioxidant, flavoring, and acidifying agent. Lactic acid is one of the earliest antibacterial substances to be harnessed by humankind. The first examples of functional chemistry in history include the fermentation of food. The most ancient example is the use of fermented milk products. For centuries people have applied the same process in preserving vegetables, sausages, cheese, and silage feed production for animals. Lactic acid bacteria are allowed to ferment and acidify these foodstuffs by producing lactic acid. In fermentation, lactic acid is the endpoint of their energy metabolism. Lactic acid is excreted to levels that inhibit competing bacteria, which happen to be the undesirable types for humans.

Lactic acid is found primarily in sour milk products, such as yogurt and cheeses. The casein in milk is coagulated (curdled) by lactic acid. Lactic acid is also responsible for the sour flavor of sourdough bread. Some beers purposely contain lactic acid. In winemaking, a bacterial process, natural or controlled, is often used to convert the naturally present malic acid to lactic acid, to reduce the sharpness and for other flavor-related reasons. Lactic acid is normally not found in any significant amount in fruit and that is the reason formulators of fruit beverage concentrates do not consider it complementary to fruit flavors. The inventor of the current teachings discovered the benefits of utilizing lactic acid to replace other acids naturally occurring in fruits.

Lactic acid, i.e., 2-hydroxypropionic acid, is an organic acid that has the molecular formula CH₃CH(OH)COOH. It is miscible with water. While in liquid state it is a colorless solution. Production includes both artificial synthesis as well as natural sources. Lactic acid is an alpha-hydroxy acid. It is produced by a microbial fermentation, wherein microorganisms convert a substrate containing carbohydrate (such as glucose) into lactic acid. Lactic acid may be classified into optical isomers of (L)-isomer and (D)-isomer based on the orientation of the hydroxyl group. Microbial fermentation can selectively produce (L)-isomers or (D)-isomers, or a racemic mixture (equal amounts of (L)-isomers and (D)-isomers), of lactic acid by choosing a suitable microorganism. Lactic acid is one of the most widely distributed acids and preservatives in nature. Food-grade lactic acid can be produced by controlled fermentation of refined sucrose or other carbohydrate sources. The compound can be purified by conversion to crystalline calcium lactate, treatment with sulfuric acid, filtration, and evaporation to yield food-grade lactic acid. Lactic acid can also be manufactured synthetically by hydrolysis of lactonitrile. A major advantage of lactic acid is that it is generally recognized as a safe (GRAS) additive according to the U.S. Food and Drug Administration.

The food industry uses different bacteria, in the form of ferments, also referred to as starter cultures, in particular lactic acid bacteria, to improve the taste and the texture of foods and also to extend their shelf life. In the dairy industry, lactic acid bacteria are used extensively to acidify milk (by fermentation) and also to give texture and flavor to the product into which they are incorporated. There are many lactic acid bacteria that are used in the food industry, including the genera Streptococcus and Lactobacillus. The lactic acid bacteria species Streptococcus thermophilus and Lactobacillus delbrueckii spp bulgaricus are used for the formulation of the ferments used to produce fermented dairy products, typically fermented milks such as yogurt. Natural L (+) lactic acid is being used in a large variety of food products such as dairy products, meat and meat products, beer, bakery products, mayonnaise, dressings, and pickles. As a food acidulant, its main functions are flavoring and preservation. Reasons for selecting lactic acid as a food acidulant are its mild acid taste which leads to flavor enhancement, its preserving properties (lactate ions are highly prohibitive to growth of many microorganisms), its natural occurrence in many foodstuffs and its natural liquid form status.

Lactic acid is a safe, biobased, and biodegradable option for antimicrobial products and formulations, with proven broad range efficacy against bacteria. L-lactic acid is an organic acid and shares several features with similar sized acids. The unique combination of low acid dissociation constant (pKa) and low hydrophobicity makes it readily miscible with water. L-lactic acid resides primarily in the water phase of an emulsion. This gives it an advantage over more hydrophobic organic acids like citric acid and malic acid because the water phase is where bacteria also reside. It is a particularly good at shuttling protons, or acidity, across cell membranes. In doing so, it does rely on low pH of the environment or medium. Once inside the cell, there are four broad-acting mechanisms that inhibit the bacterial cell. Firstly, acid stress disrupts cell regulation on a general level. Secondly, bacteria spend energy to maintain pH, by pumping out acid. Thirdly, bacteria change their metabolism to produce alkaline metabolites, and lastly, stress generates free radicals that damage all cellular mechanisms. Bacteria exposed to lactic acid cannot respond by adapting their structure or their metabolism for survival. The sudden severe acid stress leads to an unmitigated shock of oxidative stress, while any survival mechanisms are suppressed by the low intracellular pH. No single adaptation could render a bacterium resistant. The generation of the oxidative stress occurs at the cell membrane, due to the malfunctioning of the Electron Transport Chain. Furthermore, lactic acid exhibits antiviral activity.

Lactic acid is effective against Gram-negative bacteria in the absence of surfactants. Gram-positive bacteria are generally less sensitive to lactic acid but are rendered susceptible by surfactants. Surfactants may be added to the inventive composition to enhance effect on Gram-positive bacteria, however, at the inventive high concentration of lactic acid, up to 70% of the concentrate, the potency of lactic acid is assured to impact all bacterial, viral, and mycotic strains.

Lactic acid suppresses the growth of many microorganisms like B. cereus, B. subtilis, B. megaterium, B. circulans, Serratia liquefaciens, Yersinia enterocolitica, Enterobacter cloacae and Aeromonas hydrophila, Clostridium botulinum, Listeria monocytogenes, Escherichia coli, Proteus mirabilis, Salmonella enteritidis, Pseudomonas aeruginosa, Staphylococcus aureus, Enterococcus faecalis as well as yeasts like Rhodotorula sp., Saccharomyces cerevisiae and Candida albicans. Lactic acid could be used as an efficient natural antimicrobial agent improving the safety of all-natural foods.

Sodium lactate and lactic acid have been determined to be safe for the use in foods and are listed as additives generally recognized as save (GRAS) by the Food and Drug Administration.

In some embodiments, the inventive composition has been microbiologically stabilized by lactic acid which exhibits higher antimicrobial activity than other acids used in the beverage industry, thus eliminating the need for preservative inclusion, and providing clean label products.

In some embodiments of the inventive composition, the lactic acid comprises about 10% to about 90% by weight water. In further embodiments, the lactic acid comprises about 88% by weight water.

Selection. of the acidulant used in various embodiments of the beverage concentrates described herein can provide substantially improved flavor and decreased aftertaste, even when the concentrate is added to water at greater than typical amounts of concentrate. In one aspect, the acid comprises at least 100 percent of lactic acid. In other aspects, citric acid, malic acid, or phosphoric acid singularly or in combination could be added to an acid blend at about 10% to about 55% by weight with lactic acid constituting the remainder of the acid blend.

It was pleasantly surprising to discover that lactic acid could be used solely to mimic so many acids that naturally occur in various fruits. For example, malic acid is the predominant, naturally occurring acid in watermelon. It was found that inclusion of lactic acid in a watermelon-flavored beverage concentrate provided significantly improved taste compared to a similar beverage concentrate containing, malic acid. Lactic acid inclusion can mimic other fruits including blackberry, cherry, apple, peach, nectarine, lychee, quince, and pear, where malic acid is the predominant, naturally occurring acid.

Similarly, in fruits where citric acid is the predominant, naturally occurring acid, for example, citrus fruits (e.g., lemon, lime, orange), strawberry, and pineapple, it was found that using lactic acid in flavored concentrates with these flavor profiles provided significantly improved taste compared to a similar beverage made with citric acid.

The pH can be established using any combination of food-grade acid, such as but not limited to citric acid, malic acid, succinic acid, acetic acid, hydrochloric acid, adipic acid, tartaric acid, fumaric acid, phosphoric acid and/or ascorbic acid in combination with lactic acid. By one approach, acid selection can be a function of the desired concentrate pH and desired taste of the diluted ready-to-drink product.

Even though many acids are known to the skilled in the art of the beverage industry, many other acids are not common to be considered for the fruit flavored beverage and concentrated beverage liquids. For instance, citric, malic, tartaric, and phosphoric acids are well known and commonly incorporated in beverage concentrates. To the contrary, some acids have never been considered in beverage concentrates due to strength unsuitability, flavor profile and homogeneity with the sweet flavors. Lactic acid, propionic acid, acetic acid, and butyric acid are well known in the dairy industries where low or no sweetness and dairy or buttery notes are required in the final product. Lactic acid imparts creamy, cooked notes, while propionic acid imparts a Swiss cheese flavor profile and butyric acid imparts a butter and aged cheese flavor profile. Acetic acid, the main acid in vinegar, imparts aroma and sourness to many food products. Butyric and propionic acids are not used in sweet fruit flavored products as they impart foreign, uncharacteristic flavors to the finished products. Similarly, based on the same assumption that dairy acids do not suit fruit flavors, lactic acid has until now not one to be considered when formulating liquid water enhancers.

Citric and malic acids have been predominantly incorporated in liquid water enhancing concentrates. Citric acid can be produced in commercial quantities by the fermentation of carbohydrate materials using various strains of citric acid producing fungi. Citric acid is an organic acid and occurs naturally in citrus fruit and imparts the harsh aftertaste of citrus fruits. Because it is one of the stronger edible acids, the dominant use of citric acid is as a flavoring and preservative in food and beverages, especially soft drinks and candies. Malic acid is the source of extreme tartness in United States-produced confectionery. It is also used with or in place of the less sour citric acid in sour sweets. These sweets are sometimes labeled with a warning stating that excessive consumption can cause irritation of the mouth. A fermentation process may convert malic acid to much milder lactic acid. Malic acid occurs naturally in all fruits and many vegetables and is generated in fruit metabolism. In some embodiments, citric and malic acids are not the main acids in the current invention. In some embodiments, lactic acid is the dominant acid. In additional embodiments, citric acid and/or malic acid is/are incorporated in small amounts to modify flavor profiles. In further embodiments, phosphoric acid and/or tartaric acid is incorporated in the concentrate along with lactic acid to affect various flavor profiles.

Each organic acid has a very different influence on taste when used as an acidulant. For instance, the flavor profiles of acetic and citric acid are sharp, whereas lactic acid has a mild acidic taste as well as a long-lasting flavor profile. Thus, lactic acid is useful for enhancing flavors, such as tomato, green herbs, pepper, and dairy. In the inventive compositions, the use of lactic acid for fruit flavors provides an optimal balance between low pH, mild taste, and effective anti-microbial activity.

Comparing malic acid with citric acid at the same concentration, malic acid has a lower pH and a more sour taste. Malic acid has a more prolonged sour sensation and for this reason a higher relative sourness. Each acidulant has different sensory characteristics. In some embodiments, astringency is considered when formulating a beverage concentrate. Astringency is the sensation of puckering or shrinking throughout the mouth. In the case of acidulants, the sensation of astringency occurs after the sensation of sourness and lasts longer. Lactic acid has much lower astringency than other acids and thus enhance true flavor perception in mouth and may appeal to consumers who prefer a more natural and milder mouthfeel.

Malic and citric acids are hygroscopic while lactic acid is non-hygroscopic which helps avoid moisture absorption and product degradation. Liquid lactic acid is a solution with little to no absorption of water. Liquid lactic acid allows for the formulation of all-liquid ingredient concentrates, wherein all liquids are mixed with minimal agitation or heat and then filled into containers.

The specific pH influence and sourness of organic acids can be explained by the acid's pKa value which is the pH at which 50% of the acid is undissociated and 50% is dissociated. Furthermore, lactic acid has a milder taste than citric or malic. When lactic acid is used, the pH of the concentrate is usually slightly higher than citric or malic acid at the same acid addition level and provides less tart or astringent taste allowing for a much higher incorporation rate of up to about 70% of concentrate composition because lactic acid does not require water for solubilization. Conversely, citric and malic acids are dry powders and require significant amounts of water for solubilization, thus limiting the incorporation rate in a specific volume.

When lactic acid is used as the main acidulant, other factors for preservation, like water activity and preservative inclusion become negligible since lactic acid has a powerful antimicrobial property. Another interesting discovery of the current invention is regarding the flowability of the concentrate as viscosity of the concentrate is not a concern since lactic acid is a liquid which enhances dispersibility in water and flowability during processing protocols. In some embodiments, lactic acid is present at about 8.0% to about 70.0% by weight of the composition. In further embodiments, lactic acid is present at about at about 10% to about 25% by weight of the composition.

Edible antimicrobials—including edible alcohols such as ethyl alcohol, propylene glycol, natural or artificial preservatives such as EDTA, sodium benzoate, potassium sorbate, sodium hexametaphosphate, nisin, natamycin, polylysine, and cultured sugars—which exist in most flavored concentrates may be eliminated in the inventive compositions due to its high concentration of lactic acid. Such elimination enhances consumer acceptance by providing clean label beverage concentrates. in some embodiments, the inventive compositions comprise substantially no edible antimicrobial and/or substantially no additional preservative.

By “shelf stable” it is meant that the concentrate avoids substantial flavor degradation and is microbially stable such that the concentrate has an aerobic plate count (APC) of less than about 5000 CFU/g, yeast and mold (YM) level of less than about 500 CFU/g, and conforms (CF) level of about 0 MPN/g for at least about six months, and in another aspect at least about twelve months, when stored at ambient temperatures. In certain embodiments, the concentrate is bactericidal and prevents germination of spores. Avoiding substantial degradation of the flavor means that there is little or no change in flavor provided by the concentrate when added to water to produce a beverage after storage at room temperature over the shelf life of the product with little or no development of off flavor notes. The current invention limits the degradation of flavor to a minimum.

Buffers may be incorporated in the concentrates. Buffers including for example, a conjugated base of an acid (e.g., sodium citrate and potassium citrate), acetate, phosphate, or any salt of an acid. In other instances, an undissociated salt of the acid can buffer the concentrate. By one approach, a buffer, such as potassium citrate, can be used to bring the pH from about 1.5 to about 3.5. Addition of buffers allows for increased addition of acid while maintaining the desired acidity level in order to produce varying flavor profiles. in some embodiments, the inventive composition comprises a salt buffer. In further embodiments, the salt buffer is independently selected from potassium phosphate, sodium phosphate, potassium citrate, calcium citrate, sodium citrate, and combinations thereof. In further embodiments, the salt buffer is potassium citrate present in an amount of about 0.2% to about 5.0% by weight of the composition. In other embodiments, the salt buffer is sodium citrate present in an amount of about 4.0% to about 22.0% by weight of the composition.

Another aspect of the current invention is a method for producing flavored concentrates. Because lactic acid is a flowable liquid, it is possible to use simple blending and mixing techniques and vessels to prepare a concentrate based on all liquid ingredients. No dry or solid ingredients are incorporated as ingredients are selected from a group of liquid components. Water, liquid flavor, lactic acid, and optional ingredients are mixable and miscible without the need to dissolve any dry component which allows for simple preparation of liquid flavored concentrates. In contrast, commercial products use various dry ingredients since citric acid, sorbate, and coloring agents are in solid state, which must be solubilized to get their full functionality and require specific mixing vessels, heating protocol and longer preparation time. The inventive methods' simple and quick mixing of liquid components, with or without heating, produce economical, yet stable concentrates with excellent shelf-life qualities. In some embodiments, liquid lactic acid is incorporated into the all-liquid mix at about 15% to about 70% by weight of the composition.

Additional aspects of the current invention include ultra-concentrated beverage liquids with lower dosing requirement than current products in the market and methods for preparing the same. Because lactic acid is liquid, it does not require water for solubilization leaving free water available to solubilize any dry ingredients. Previously, when citric acid or phosphoric acid was used as the acidulant, acid percentage in the concentrate was limited to free water available, thus reducing the maximum amount of acid that could be incorporated, in the current invention, acid concentrations may reach about 70% of the concentrate when lactic acid is used alone or in combination with low levels of one or more other acid(s) such as phosphoric acid, citric acid and/or malic acid. When coupled with concentrated flavorings, coloring agents and sweeteners, a surprisingly low dosing concentrate with high flavor impact is produced. Cold filling into containers is feasible without risk of spoilage because of the high concentration of lactic acid.

In some embodiments, a serving size of about 0.4 to 1.0 ml is added to about 8 to 16 oz. of water to produce a good tasting final beverage. The inventive compositions may be used with dosing systems like vending and dispensing machines to add an extra dose of flavor or nutritional boost to beverages. Moreover, the ultra-concentrated liquid may be filled into smaller dispensing portable packages or double the number of servings of an ordinary container in the marketplace. For example, current liquid water enhancer concentrates in the marketplace are filled in about 48 ml squeeze bottles with silicone valve to deliver about 24 servings of 2 ml each. When the inventive ultra-concentrate is filled into the same 48 ml container, the number of servings can increase, for example, up to about 48 servings of 1 nil each. The inventive compositions can provide an economic value to both consumers and manufacturers.

Liquid lactic acid reduces the need for water inclusion which in turn reduce the water activity of the concentrates, thus providing better microbial resistance and flavor stability. Additionally, freeing water allows for incorporating higher levels of other beneficial nutrients like electrolytes to produce thirst quenching products. Inasmuch as the use of liquid lactic acid eliminates the need for any water inclusion in the formulations, low water activity concentrates with water activity value of about 0.1 may be produced. Many water activities values could be manipulated, ranging from about 0.10 to 0.95, by varying the amount of water and lactic acid. addition. The current invention is the first to elucidate how to formulate flavored concentrates with water activity of about 0.50 or less. Moreover, the current invention is the only composition. produced with undetectable water activity in a flowable composition that is characterized by acidic, sweet, and fruity attributes.

The current invention may employ a humectant to produce concentrates with extremely low water activity of about 0.50 or less. In some embodiments, about 50% glycerin is used along with lactic acid to produce a concentrate of about 0.20 water activity. Varying amount of humectant may produce a gradient of water activity levels. A humectant is a hygroscopic substance with an affinity to form hydrogen bonds with molecules of water. It is often a molecule with several hydrophilic groups, most often hydroxyl groups, but amine and carboxyl groups, sometimes esterified, may be included as well. Since hygroscopic substances absorb water from the air, they are frequently used in desiccation. When used as a food additive, the humectant has the effect of keeping the foodstuff moist. Humectants reduce the water activity of liquid. Water activity or a_{w} is a measurement of the energy status of the water in a system. It is defined as the vapor pressure of water divided by that of pure water at the same temperature; therefore, pure distilled water has a water activity of exactly one.

There are several factors that control water activity in a system: colligative effects of dissolved species (e.g., salt or sugar) interacting with water through dipole-dipole, ionic, and hydrogen bonds; capillary effect where the vapor pressure of water above a curved liquid meniscus is less than that of pure water because of changes in the hydrogen bonding between water molecules; surface interactions in which water interacts directly with chemical groups on undissolved ingredients (e.g., starches and proteins) through dipole-dipole forces, ionic bonds (H₃O+ or OH—), van der Waals forces (hydrophobic bonds), and hydrogen bonds. It is the combination of these three factors in a food product that reduces the energy of the water and, thus, reduces the relative humidity as compared to pure water.

Water activity is also temperature dependent. Temperature changes water activity due to changes in water binding, dissociation of water, solubility of solutes in water, and/or the state of the sample matrix.

If dry powder acids like citric, malic, and phosphoric are added to glycerin, they will precipitate out and form a layer at the bottom of the container due to lack of sufficient water to dissolve them. The higher the amount of acid, the higher the amount of water needed and the lower the amount of humectant that could be present. A pleasantly surprising finding of the current invention is that any amount of lactic acid could be mixed with any amount of a humectant (such as glycerin, maltitol and/or other liquid sugar alcohols) without precipitation out, thus impacting the gradient of sourness in the final diluted beverage. Lactic acid with various levels of water (from about 10% to about 88% by weight) could be utilized in the concentrate when low water activity is not desired. Nonetheless, when concentrates with no added water are formulated, all the water content may come exclusively from lactic acid. Therefore, the lowest naturally available water content of lactic acid could be utilized. In one embodiment, lactic acid at about 90% w/w concentration could be used, providing about 18% by weight water content in the resulting concentrate. When dry ingredients (like sweeteners and coloring agents) are added, water activity is reduced. Mixing about 50% glycerin with about 40% lactic acid reduces the water activity to about 0.30 or less while providing sufficient water to dissolve artificial sweeteners yet providing low pH in the concentrate and high degree of sour notes in the final diluted beverage.

The current concentrates can optionally include coloring agents (artificial and/or natural), flavorings (artificial and/or natural), sweeteners (artificial and/or natural), caffeine, electrolytes (including salts), nutrients (e.g., vitamins and minerals), and the like. Preservatives, such as sorbate or benzoate, can be included, if desired, but are generally not necessary for shelf stability. The present compositions and methods can optionally contain a variety of additional ingredients suitable for rendering such products more organoleptically acceptable, more nutritious, and/or more storage stable. Such optional components may include lipids, coloring agents, preservatives, acidity, and pH modifiers (acidic or alkaline) Of course, mixtures of the above-noted materials are contemplated herein. The concentrates can contain any combination of the additives or ingredients described herein, such as water, flavorings, nutrients, coloring agents, sweeteners, salts, buffers, gums, caffeine, stabilizers, and the like. Optional preservatives, such as sorbate or benzoate can be included, but are not required to maintain shelf stability. Ascorbic acid in an amount from about 0.5% to about 20.0% by weight based on the weight of concentrate may be incorporated to provide a nutritional beverage concentrate with high vitamin C content ranging from about 10 mg to about 400 mg per 2 ml serving. If ascorbic acid is included, a buffer could also be added to raise the pH up to about 3.0 to about 3.5 to preserve the flavor and color integrity throughout the shelf life.

Many optional ingredient additives can be included in the concentrates. Flavors can include, for example, fruits, tea, coffee and the like and combinations thereof. The flavors can be provided in various types and forms, including alcohol-containing flavorings (such as ethanol- or propylene glycol-containing flavorings), flavor emulsions, extruded flavorings, liquid, and spray-dried flavorings. A variety of commercially available flavorings can be used. The flavorings can be included at about 1% to about 30% or, in another embodiment about 2% to about 20%, by weight of the beverage concentrates. The precise amounts of flavorings included in the concentrate will vary depending on the concentration of the liquid beverage concentrate, the concentration of the flavor key in the flavoring, and the desired flavor profile of the resulting beverage. Generally, extruded and spray-dried flavorings can be included in lesser amounts than alcohol-containing flavorings and flavor emulsions because the extruded and spray-dried flavorings often include a larger percentage of flavor key. In some embodiments, the concentrate includes a sweetener. Useful sweeteners may include, for example, honey, agave syrup, sugar, erythritol, sucralose, aspartame, stevia, saccharine, monatin, luo han guo (monk fruit), neotame, sucrose, Rebaudioside A (often referred to as “Reb A”), fructose, cyclamates such as sodium cyclamate), acesulfame potassium or any other nutritive or non-nutritive sweetener and combinations thereof. In some embodiments, an artificial sweetener is present in the flavored concentrate composition in an amount of about 0.3% to about 5.0% by weight of the concentrate. In further embodiments, the artificial sweetener is present in an amount about 0.5% to about 2.5% by weight of the concentrate. In some embodiments, a natural sweetener is present in the flavored concentrate composition in an amount of about 30.0% to about 60% by weight of the concentrate. In further embodiments, the sweetener is agave syrup and is present in an amount of about 30% to about 65% by weight of the concentrate.

The containers suitable for filling the current liquid concentrates include thermoformed packages, squeeze bottles with silicone valves or dispensing caps, droppers, pumps, dispensing machines known in the an and the like. in some embodiments, the liquid concentrates are advantageously suitable for cold filling while maintaining shelf stability for at least about six months and, in further embodiments, for at least about twelve months, at ambient temperatures.

The current invention also provides kits comprising the flavored beverage concentrate composition. In some embodiments, the kit comprises a beverage concentrate composition made using lactic acid and a container as disclosed herein. The kit offers portability, multiuse and shelf stability.

Methods of Preparation

The current invention further provides methods of preparing flavored beverage concentrate compositions in various flavors, wherein the compositions are shelf-stable at ambient temperature.

The flavored beverage concentrate compositions can be prepared, for example, in a batch or a continuous mixing device. The batch mixers used can be of any type of mixer. In some embodiments, a continuous mixer is employed. Pasteurization (if desired) and cooling steps could be performed in batch processing or continuous HTST equipment.

In some embodiments, the method comprises mixing about 8.0% to about 70.0% acid, about 1.0% to about 12.0% buffer, about 1.0% to about 30.0% flavoring, and about 30% to about 80% water to produce a flavored beverage concentrate having a pH of about 1.0 to about 3.5 and, in further embodiments, a pH of about 0.7 to about 2.6. In additional embodiments, the method further comprises packaging the concentrate in an airtight, container with or without pasteurization.

Any combination of the ingredients and components as described herein may be employed in preparing the flavored concentrate compositions. The above-described compositions may be manufactured in any manner known to those skilled in the art. In some embodiments, the method of preparing the composition comprises first adding lactic acid to deionized water at about 65° to about 75° F., and then adding flavoring(s), coloring agent(s) and/or sweetener(s). In additional embodiments, the method further comprises mixing the lactic acid, water, and flavoring(s), coloring agent(s) and/or sweetener(s) for about fifteen minutes. In yet additional embodiments, the method further comprises heating the lactic acid, water, and flavoring(s), coloring agent(s) and/or sweetener(s) to a temperature of about 155° to about 210° F. for about 5 to about 20 minutes.

In some embodiments, the method produces in one batch about 1,000 pounds of the shelf-stable liquid flavored concentrate composition. In further embodiments, the method produces a composition comprising about 40% to about 80% by weight water, about 8.0% to about 22% by weight lactic acid, and about 2.0% to about 30% sweetener.

Another aspect of the invention provides a method for preparing an all-liquid (no solids are added) flavored concentrate composition, comprising mixing about 50% to about 80% liquid lactic acid with about 0.5% to about 1.0% liquid flavoring(s), about 1.0% to about 3% high intensity sweetener syrup, and about 10.0% to about 30.0% glycerin as a humectant.

In some embodiments, the method produces in one batch about 22,000 pounds of the shelf-stable flavored concentrate composition. In further embodiments, the method produces a composition comprising about 70% to about 80% by weight water, about 15% to about 27% by weight lactic acid, and about 0.5% to about 2.5% by weight high intensity sweetener.

In further embodiments, the method further comprises dispensing the flavored concentrate composition in small single serving packages pre-measured for use with a standard 12 or 16-ounce water bottle. The packages may be of any shape, form or size.

### EXAMPLES

This invention is further illustrated by the following examples, which are to be regarded as illustrative only, and in no way limit the scope of the invention. The following non-limiting examples and data illustrate various aspects and features relating to the method(s) and resulting products/compositions of this invention, including the surprising and unexpected modification, control and/or improvement of the water activity level, homogenization, emulsion formation, solubility of actives and improvement of energy level and mood elevation.

### Example 1

The pH, taste, and mouthfeel of lactic, citric, and malic acids are compared. With each acid, 22 g of the acid is mixed in 78 ml of water, then 2 ml of the mixture is diluted in 250 ml of water, and pH readings of the diluted solutions are obtained. The lactic acid solution has the highest pH value and the most pleasant taste and mouthfeel with the least sour note and astringency left in the mouth.

| | Lactic | Citric | Malic |
|---|---|---|---|
| | Acid | Acid | Acid |
| Acid (% by weight) | 22 | 22 | 22 |
| Water (% by weight) | 78 | 78 | 78 |
| Total (% by weight) | 100 | 100 | 100 |
| pH | 1.45 | 1.15 | 1.33 |

### Example 2

The impact of adding a buffer to solutions of lactic, citric, and malic acid is researched. With each acid, 22 g of the acid is mixed with 2 g of sodium citrate in 76 ml of water, and pH readings of the concentrates are obtained, then 2 ml of the concentrates is diluted in 250 ml of water and the resulting solutions were evaluated for taste and mouthfeel.

| | Lactic | Citric | Malic |
|---|---|---|---|
| | Acid | Acid | Acid |
| Acid (% by weight) | 22 | 22 | 22 |
| Water (% by weight) | 76 | 76 | 76 |
| Sodium Citrate (% by weight) | 2 | 2 | 2 |
| Total (%) | 100 | 100 | 100 |
| pH | 2.49 | 2.02 | 2.12 |

The lactic acid solution has the highest pH and the most pleasant taste and mouthfeel with the least sour note and astringency left in the mouth. The delta pH, when compared to concentrates without buffer shown in example 1, are 0.79 for the malic acid solution, 0.87 for the citric acid solution, and 1.04 for the lactic acid solution. The data indicate that lactic acid's buffering capacity is lower than that of the other two acids and, hence, may need lower amounts of buffer to achieve the same pH value as the other two acids in the presence of buffers.

### Example 3

The following compositions are formulated by first heating deionized water to 75°-80° F. Lactic acid and an intensive sweetener are added simultaneously to the heated water and mixed for five minutes. While maintaining the temperature of the mixture at 75°−80° F., a liquid flavoring, fruit juice concentrate, and natural coloring agent are added and mixed for five minutes. The mixture is heated to between about 190° F. and 215° F. The flavored concentrate is packaged after cooling to about 70° F.

| | A | B | C | D |
|---|---|---|---|---|
| Lactic Acid (% by weight) | 8.00 | 16.00 | 24.00 | 32.00 |
| Sucralose (% by weight) | 2.20 | 2.20 | 2.50 | 2.50 |
| Natural Red Coloring Agent (% | — | 2.00 | 2.00 | 2.00 |
| by weight) | | | | |
| Natural Fruit Punch Flavoring | 2.00 | 2.00 | 3.00 | 3.00 |
| (% by weight) | | | | |
| Water (% by weight) | 87.80 | 77.80 | 68.50 | 60.50 |
| Total (% by weight) | 100.00 | 100.00 | 100.00 | 100.00 |
| Concentrate pH | 1.7 | 1.67 | 1.55 | 1.45 |

Each concentrate is diluted in water at the ratio of 1:120 concentrate to water (one part concentrate added to 120 parts water). All diluted concentrates of A, B, C, and D exhibit desirable taste, color, and flavor. All pH values are in an acceptable range to provide protection against spoilage and pathogenic microorganisms. Even at the highest addition level, lactic acid is found to accentuate the fruit flavor profile with a pleasant acidic note void of astringency and aftertaste. The data surprisingly indicate that the amount of lactic acid could be quadrupled without deteriorating the taste of the concentrate which is not expected when other acids are used.

### Example 4

The following compositions are formulated by first heating deionized water to about 75°−80° F. Lactic, citric, and malic acids and sweetener are added to the heated water and mixed for five minutes. While maintaining the temperature of the mixture at 90°−100° F., flavoring and coloring agent are added. The mixture is mixed for twenty minutes. The resulting flavored concentrate is then cold filled into containers.

| | E | F | G |
|---|---|---|---|
| Lactic Acid (% by weight) | 15.00 | 15.00 | 22.00 |
| Sucralose (% by weight) | 2.50 | 2.50 | 2.50 |
| Citric Acid (% by weight) | 6.00 | — | 2.00 |
| Malic Acid (% by weight) | — | 6.00 | 2.00 |
| Red Dye 40 (% by weight) | 0.10 | 0.10 | 0.20 |
| Artificial Fruit Punch Flavoring | 2.50 | 2.50 | 5.00 |
| (% by weight) | | | |
| Water (% by weight) | 73.90 | 73.90 | 66.30 |
| Total (% by weight) | 100.00 | 100.00 | 100.00 |
| Concentrate pH | 1.45 | 1.47 | 1.41 |

Each concentrate is diluted in water at the ratio of 1:120 concentrate to water (one part concentrate added to 120 parts water). All diluted concentrates of E, F and G exhibit desirable taste, color, and flavor. All pH values are in an acceptable range to provide protection against spoilage and pathogenic microorganisms. Lactic acid as a dominant acid, with smaller amounts of citric acid and malic acid, accentuates the fruit flavor profile with pleasant acidic note void of astringency and aftertaste.

### Example 5

An ultra-concentrated, flavored composition is prepared by first placing deionized water to into a mixing vessel. Lactic acid, citric acid, flavoring, coloring agent, trisodium citrate, and sweetener are added to the water and mixed for five minutes. The mixture is heated to and maintained at 175-190° F. for twenty minutes. The mixture is cooled to ambient temperature. The flavored concentrate is filled into containers with pumps to be pumped into various beverages as a booster or mixed with water to provide finished beverages.

| | H | I | J | K |
|---|---|---|---|---|
| Lactic Acid (% by weight) | 40.00 | 40.00 | 40.00 | 65.00 |
| Citric Acid (% by weight) | 23.00 | 23.00 | 23.00 | 8.00 |
| Sucralose (% by weight) | 5.00 | 5.00 | 5.00 | 5.00 |
| Trisodium Citrate (% by weight) | — | 5.00 | 12.00 | — |
| Red Dye 40 (% by weight) | 0.20 | 0.20 | 0.20 | 0.20 |
| Artificial Fruit Punch Flavoring | 5.00 | 5.00 | 5.00 | 5.00 |
| (% by weight) | | | | |
| Water (% by weight) | 26.80 | 21.80 | 14.80 | 16.80 |
| Total (% by weight) | 100.00 | 100.00 | 100.00 | 100.00 |
| Concentrate pH | 1.61 | 2.02 | 2.47 | 1.23 |

Each ultra-concentrate is diluted in water at the ratio of 1:240 concentrate to water (one part concentrate added to 240 parts water). All diluted concentrates of H, I, J and K exhibit desirable taste, color, and flavor. The use of liquid lactic acid allows for high levels of citric acid to be incorporated, even with a minimal amount of water present, which would have been impossible to achieve without the liquidity and flowability of lactic acid as a carrier medium. When each ultra-concentrate is diluted in water at the ratio of 1:480 (one part concentrate added to 480 parts water), similarly pleasant taste, color, and flavor are obtained. To counter any damaging impact of the concentrates' high acid concentration on their natural flavoring(s) and coloring agent(s), artificial flavoring(s) and synthetic coloring agent(s) may be used to offer stability over extended shelf life. Citric acid may be substituted with ascorbic acid to achieve a high level of vitamin C as well as a pleasant acidic note and flavor profile in the finished beverage.

### Example 6

An all-liquid ingredient shelf-stable concentrate is prepared. The liquid ingredients are added in a vessel and mixed with a hand mixer for five minutes. Without any further mixing or heating, the resulting concentrate is ready to be filled into containers.

| | L | M |
|---|---|---|
| Lactic Acid (% by weight) | 20.00 | 27.00 |
| Agave Syrup (% by weight) | 34.00 | 35.00 |
| Strawberry Juice Concentrate (% by weight) | 5.00 | 5.00 |
| Natural Strawberry Flavoring (% by weight) | 2.50 | 3.50 |
| Water (% by weight) | 38.50 | 29.50 |
| Total (% by weight) | 100.00 | 100.00 |

Upon dilution in water at various mixing ratios, the diluted concentrates exhibit organoleptic characteristics like those of other beverages made from concentrates prepared utilizing a conventional manufacturing process.

### Example 7

Low water activity compositions are formulated with mostly liquid ingredients except for sucralose and trisodium citrate. All ingredients are blended at no specific order at ambient temperature. After mixing for 20 minutes, the resulting concentrate is packaged in squeeze bottles or bottles with dispensing pumps.

| | O | P | Q | R | S |
|---|---|---|---|---|---|
| Liquid Lactic Acid (% by | 42.00 | 70.00 | 86.00 | 90.00 | 65.00 |
| weight) | | | | | |
| Sucralose (% by weight) | 3.00 | 4.00 | 4.00 | 4.00 | 7.00 |
| Trisodium Citrate (% by | — | — | 4.00 | — | — |
| weight) | | | | | |
| Liquid Shade Red | 1.00 | 1.00 | 1.00 | 1.00 | 1.00 |
| Coloring Agent (% by | | | | | |
| weight) | | | | | |
| Liquid Fruit Punch | 3.00 | 5.00 | 5.00 | 5.00 | 27.00 |
| Flavoring (% by weight) | | | | | |
| Glycerin (% by weight) | 51.00 | 20.00 | — | — | — |
| Total (% by weight) | 100.00 | 100.00 | 100.00 | 100.00 | 100.00 |
| Water Content | 5.04 | 8.40 | 10.32 | 10.80 | 7.80 |
| Concentrate Water | 0.21 | 0.41 | 0.48 | 0.49 | 0.32 |
| Activity | | | | | |
| Concentrate pH | 1.54 | 0.69 | 2.04 | 1.01 | 1.34 |

In most compositions, lactic acid is the major ingredient. In formula 0, a high amount of glycerin is added to produce a flowable, liquid concentrate with a low water activity of about 0.21. While no water beyond the water in the ingredients themselves is added, the glycerin and lactic acid help maintain the liquidity and flowability of the compositions. Composition 0 has a significantly reduced water activity of 0.21, which is close to being undetectable while providing flavor stability and microbiological properties that, until the present invention, was achievable in only dry and powdered compositions that are void of any water content.

It is surprising to discover that dry sucralose and sodium citrates dissolve in the no-water added compositions. The liquid lactic acid has a concentration of about 88% by weight lactic acid and about 12% water. It is plausible that the water content of lactic acid is responsible for dissolving the small amount of dry ingredients. However, if more solids such as dry acids are used, precipitation may occur, thereby rendering the concentrate unusable and not processable. Coloring agents and flavorings are usually produced in water-free or low-water content bases so they do not contribute much moisture to the finished concentrates.

In composition S, glycerin is omitted, and a flavoring is included at a high level of 27%. Sucralose is increased to balance out the impact of high levels of flavoring and lactic acid on taste perception. Natural and artificial flavorings may provide diluents and carriers that can impact water activity to various degrees. Flavorings having various water, solvent, and humectant contents may also contribute water for dissolving solids in the concentrates or for raising the water content in the concentrates.

Upon dilution in water, all concentrates exhibit excellent appearance, taste, and flavor profiles at very low dosing. To evaluate organoleptic properties, about 0.20 ml to about 0.3 ml of concentrate is mixed in about 8 ounces of water. Dosing parameters can be adjusted to achieve various flavor, acidity, and sweetness intensities in the final beverage.

It will be apparent to those skilled in the art that the disclosed subject matter may be directed to one or more of the above- and below-indicated embodiments in any combination, and changes may be made, and equivalents may be substituted without departing from the spirit and scope of the invention. Hence, the description and examples should not be construed as limiting the scope of the invention. All references, publications, patents, and patent applications disclosed herein are hereby incorporated by reference in their entirety as if each had been individually incorporated.

1. A shelf-stable liquid flavored beverage concentrate composition comprising:
a flavoring;
lactic acid at about 8% to about 90% by weight of the composition; and
water at about 0% to about 88% by weight of the composition.

2. The shelf-stable liquid flavored beverage concentrate composition according to claim 1, wherein the flavoring constitutes from about 1% to about 30% by weight of the composition.

3. The shelf-stable liquid flavored beverage concentrate composition according to claim 1, wherein water constitutes about 10% to about 90% by weight of the lactic acid.

4. The shelf-stable liquid flavored beverage concentrate composition according to claim 1, wherein the water constitutes total water content contributed by direct addition of water and/or other components of the composition.

5. The shelf-stable liquid flavored beverage concentrate composition according to claim 1, further comprising citric acid in an amount from about 23.0% to about 26.0% by weight of the composition.

6. The shelf-stable liquid flavored beverage concentrate composition according to claim 1, further comprising malic acid in an amount from about 23.0% to about 26.0% by weight of the composition.

7. The shelf-stable liquid flavored beverage concentrate composition according to claim 1, further comprising ascorbic acid in an amount from about 0.5% to about 23.0% by weight of the composition.

8. The shelf-stable liquid flavored beverage concentrate composition according to claim 7, further comprising phosphoric acid in an amount from about 23.0% to about 26.0% by weight of the composition.

9. (canceled)

10. (canceled)

11. (canceled)

12. (canceled)

13. (canceled)

14. The shelf-stable liquid flavored beverage concentrate composition according to claim 1, further comprising a buffer in an amount from about 2.0% to about 12.0% by weight of the composition.

15. The shelf-stable liquid flavored beverage concentrate composition according to claim 15, wherein the buffer comprises one or more components independently selected from potassium phosphate, sodium phosphate, potassium citrate, calcium citrate, and sodium citrate.

16. The shelf-stable liquid flavored beverage concentrate composition according to claim 1, wherein the composition comprises substantially no edible antimicrobial or additional preservative.

17. The shelf-stable liquid flavored beverage concentrate composition according to claim 1, wherein the composition has a water activity of about 0.50 or less.

18. The shelf-stable liquid flavored beverage concentrate composition according to claim 1, wherein the composition has a water activity of about 0.30 or less.

19. A shelf-stable liquid flavored beverage concentrate composition comprising:
a liquid flavoring;
liquid lactic acid at about 60% to about 90% by weight of the composition; and
liquid humectant at about 20% to about 50% by weight of the composition;
wherein all components of the composition are liquid.

20. The shelf-stable liquid flavored beverage concentrate composition according to claim 19, wherein the composition comprises substantially no edible antimicrobial or additional preservative.

21. The shelf-stable liquid flavored beverage concentrate composition according to claim 19, wherein the composition has a water activity of about 0.50 or less.

22. A shelf-stable liquid flavored beverage concentrate composition comprising:
a liquid flavoring at about 2-20%; and
a liquid lactic acid at about 80% to about 90% by weight of the composition; and
a non-nutritive sweetener at about 4-8% by weight of the composition; and
a liquid coloring agent at about 1-2% by weight of the composition.

23. The shelf-stable liquid flavored beverage concentrate composition according to claim 22, wherein the composition comprises substantially no edible antimicrobial or additional preservative.

24. The shelf-stable liquid flavored beverage concentrate composition according to claim 22, wherein the composition has a water activity of about 0.50 or less.

25. A beverage package kit comprising the shelf-stable liquid flavored beverage concentrate composition of claim 1, and a container suitable for delivering the shelf-stable liquid flavored beverage concentrate composition.
